(19) United States
(12) Patent Application Publication
(10) Pub. No.: US 2008/0126637 A1
(43) Pub. Date: May 29, 2008

(54) NETWORK CONTROL CIRCUIT

(76) Inventor: Takashi Ide, Nara (JP)

Correspondence Address: MCDERMOTT WILL & EMERY LLP, 600 13TH STREET, NW, WASHINGTON, DC, 20005-3096, US

(21) Appl. No.: 11/942,944

(22) Filed: Nov. 20, 2007

(30) Foreign Application Priority Data
Nov. 24, 2006 (JP) 2006-317660

(51) Int. Cl. G06F 13/42

(52) U.S. Cl. 710/106

(57) ABSTRACT

A network control circuit that is connected to a controller and a shared memory via busses and to an external apparatus via a network, and stands between the controller and the external apparatus, the network control circuit comprising: a transmission/reception unit operable to transmit/receive data having a prescribed size to/from the external apparatus in each of transmission cycles of the network; a buffer memory operable to store the data; and a read/write unit operable to read data having a size not greater than the prescribed size from the buffer memory/the shared memory, and write the read data into the shared memory/the buffer memory within a prescribed period included in each of the transmission cycles in which the controller does not use the busses, the size of the data to read depending on a storage status of the buffer memory.

### BACKGROUND OF THE INVENTION

(1) Field of the Invention

The present invention relates to a bus arbitration technique.

(2) Description of the Related Art

A technique for bus arbitration using DMA (Direct Memory Access) has been conventionally disclosed. For example, in a system in which a plurality of devices are connected to a single bus, any of the devices makes a bus-release request to a controller in order to access a shared memory connected to the bus, and accesses the shared memory after receiving a bus-release permission from the controller.

Meanwhile, a device connected to the bus sometimes stores a large volume of data in the shared memory. For example, a network control circuit, which performs data communication with external devices connected thereto via a network, stores data received from the external devices into the shared memory. In this case, the data size might be as large as the capacity of a CD or a DVD disc. However, even in such a case, the network control circuit is required to make a bus-release request to the controller in order to access the shared memory. As a result, the network control circuit frequently makes bus-release requests to the controller to store the large volume of data in the shared memory.

However, if the network control circuit frequently makes bus-release requests, the controller has to perform a bus-release operation each time. This increases the processing load.

To solve this problem, it is possible to provide the network control circuit with a large-capacity buffer memory for temporal storage of data, to reduce the frequency of the bus-release requests. However, if this is the case, many resources are required for the network control circuit. This is not preferable in terms of the cost.

As described above, the processing load on the controller and the capacity of the buffer memory to be incorporated in the network control circuit are tradeoffs, and it is difficult to reduce both of them.

### SUMMARY OF THE INVENTION

The present invention is made in view of the problem described above. The object of the present invention is to provide a network control circuit that reduces processing load on a controller without increasing a capacity of a buffer memory.

The above object is fulfilled by a network control circuit that is connected to a controller and a shared memory via busses and to an external apparatus via a network, and stands between the controller and the external apparatus, the network control circuit comprising: a transmission/reception unit operable to transmit/receive data having a prescribed size to/from the external apparatus in each of transmission cycles of the network; a buffer memory operable to store the data; and a read/write unit operable to read data having a size not greater than the prescribed size from the buffer memory/the shared memory, and write the read data into the shared memory/the buffer memory within a prescribed period included in each of the transmission cycles in which the controller does not use the busses, the size of the data to read depending on a storage status of the buffer memory.

With the stated structure, the network control circuit can access the shared memory without making a bus-release request to the controller. Accordingly, the controller is not required to perform processing for releasing the busses, and it is possible to improve the processing efficiency of the controller.

Also, in a period in which the controller does not use the busses, a period for accessing the shared memory is given to the network control circuit. As a result, in the access period, it is possible to write or read data having, at a maximum, a size that is the same as the size transmittable within the cycle, into or from the shared memory, where the size depends on the storage status of the buffer memory. In other words, even if a prescribed amount of data is received or transmitted in each cycle, the network control circuit can write or read data having the same size into or from the shared memory in each cycle. Accordingly, it is unnecessary to provide a large-size buffer memory in the network control circuit.

Here, the network control circuit may further comprise a count unit operable to decrement a count value that has been set by the controller, wherein the prescribed period is a period between when the count value is set and when the count value reaches a prescribed value.

With the stated simple structure, it is possible to secure an access period for the network control circuit. The access period for accessing the shared memory is given to the network control circuit until the count value set by the controller returns to the initial value. Therefore, it is unnecessary to provide a large-size buffer memory in the network control circuit. Also, since the controller manages all the busses by itself, it is easy to estimate the performance.

Here, the read/write unit may include a reception subunit operable to receive, from the controller, a bus access permission signal indicating a permission for access to the busses, and the prescribed period may be a period during which the reception subunit is receiving the bus access permission signal.

With the stated simple structure, it is possible to secure an access period for the network control circuit. The access period for accessing the shared memory is given to the network control circuit while the reception unit is receiving the bus access permission signal. Therefore, it is unnecessary to provide a large-size buffer memory in the network control circuit. Also, since the controller manages all the busses by itself, it is easy to estimate the performance.

Here, the read/write unit may include a reception subunit operable to receive, from the controller, an emergency bus-release request signal that requests to release the busses, and a control subunit operable to forcibly suspend processing performed by the read/write unit for a period during which the emergency bus-release request is being asserted, and cause the read/write unit to resume the processing when the emergency bus-release request is negated.

With the stated structure, if the controller is demanded to perform emergency processing when the network control circuit uses the busses, the controller can execute the processing.

Another aspect of the present invention is a network control circuit that is connected to a controller via a first bus, to a shared memory via a second bus, and to an external apparatus via a network, and stands between the controller and the external apparatus, the network control circuit comprising: a transmission/reception unit operable to transmit/receive data having a prescribed size to/from the external apparatus in each of transmission cycles of the network; a buffer memory operable to store the data; a detection unit operable to detect an access from the controller to the shared memory; a first read/write unit operable to write the data having the prescribed size into the shared memory, or read the data having the prescribed size from the shared memory; a second read/write unit operable to access the shared memory to read or write data when the detection unit detects the access from the controller to the shared memory; and a transmission unit operable to transmit a wait signal to the controller when the detection unit detects the access from the controller to the shared memory, in order to restrict a further access from the controller to the shared memory during a period from when the detection unit detects the access to when the second read/write unit finishes accessing the shared memory.

With the stated structure, it is unnecessary for the controller to control the access to the busses performed by the network control circuit. Accordingly, it is possible to reduce the processing load on the controller. Also, since the network control circuit can write or read data having a size that is the same as the size transmittable within the cycle, into or from the shared memory, it is unnecessary to provide a large-size buffer memory in the network control circuit.

Here, the network control circuit may further comprise a storage unit that stores address information showing a prescribed range of addresses of memory areas included in the shared memory; and a control unit operable to permit only access from the controller when the controller accesses an address included within the prescribed range.

With the stated structure, if the controller has to perform calculation within a prescribed time period using data stored in the shared memory, it is possible to avoid that the access time becomes long. As a result, it is possible to ensure that the calculation is completed within the prescribed time period.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a system diagram;

FIG. 2 is an internal structure diagram showing the internal structure of a car navigation apparatus 100;

FIG. 3 is shows a data structure;

FIG. 4 shows specifications of accesses from a network control circuit 30 to busses, performed at reception of data from a CD changer 200;

FIG. 5 shows transition of the size of data to be stored in a buffer memory 32;

FIG. 6 shows specifications of accesses from the network control circuit 30 to the busses in the case where a controller 10 outputs an emergency bus-release request signal 46 to the network control circuit 30;

FIG. 7 is an internal structure diagram showing the internal structure of a car navigation apparatus 100a;

FIG. 8 is an internal structure diagram showing the internal structure of a car navigation apparatus 100b;

FIG. 9 shows specifications of accesses to the busses, performed at reception of data from a network 300;

FIG. 10 shows specifications of accesses to the busses, performed at transmission of data to a network 300; and

FIG. 11 shows an internal structure diagram showing the internal structure of a car navigation apparatus 100c.

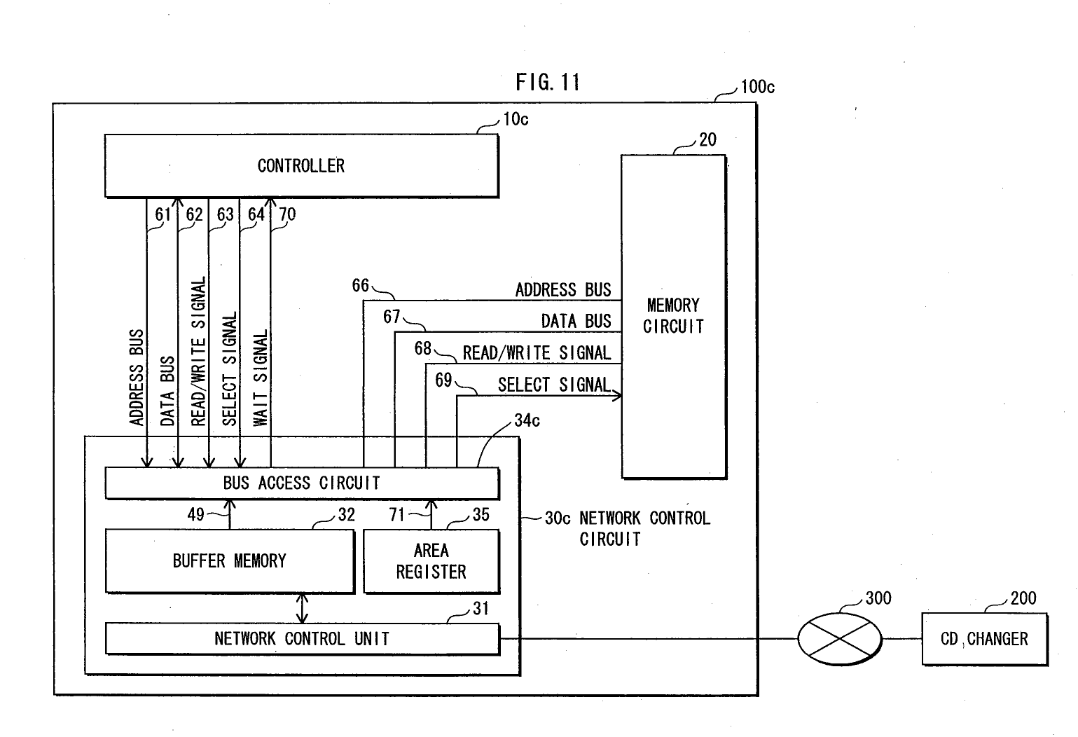

### DESCRIPTION OF THE PREFERRED EMBODIMENTS

### The First Embodiment

### <Outline>

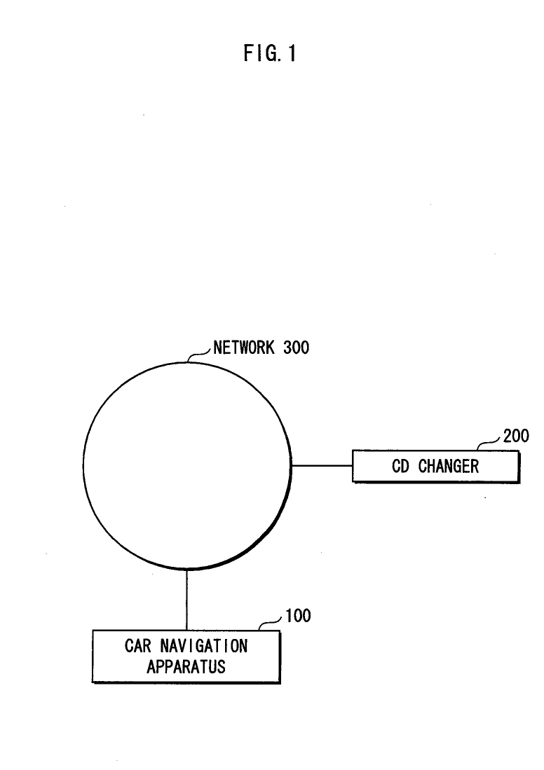

Firstly, the following describes an outline of a network control circuit 30 pertaining to the present invention. A system illustrated in FIG. 1 is an in-vehicle network system that includes a car navigation system 100, a CD changer 200, and a network 300. The in-vehicle network system is a multimedia network, such as the MOST (Media Oriented Systems Transport), that allows user to enjoy DVDs or the like in a car. The MOST is a network based on the ring topology that uses plastic optic fiber (POF), by which devices such as a car navigation apparatus, an audio apparatus, and ETC (Electronic Toll Collection) are interconnected.

The network control circuit 30 is provided in the car navigation apparatus 100, and has a function to perform data communication with the CD changer 200 via the network 300. The subject data is, for example, map information and music data, etc.

This concludes the outline of the network control circuit 30.

Next, the network control circuit 30 pertaining to the present invention is described in detail, with reference to the drawings.

### <Structure>

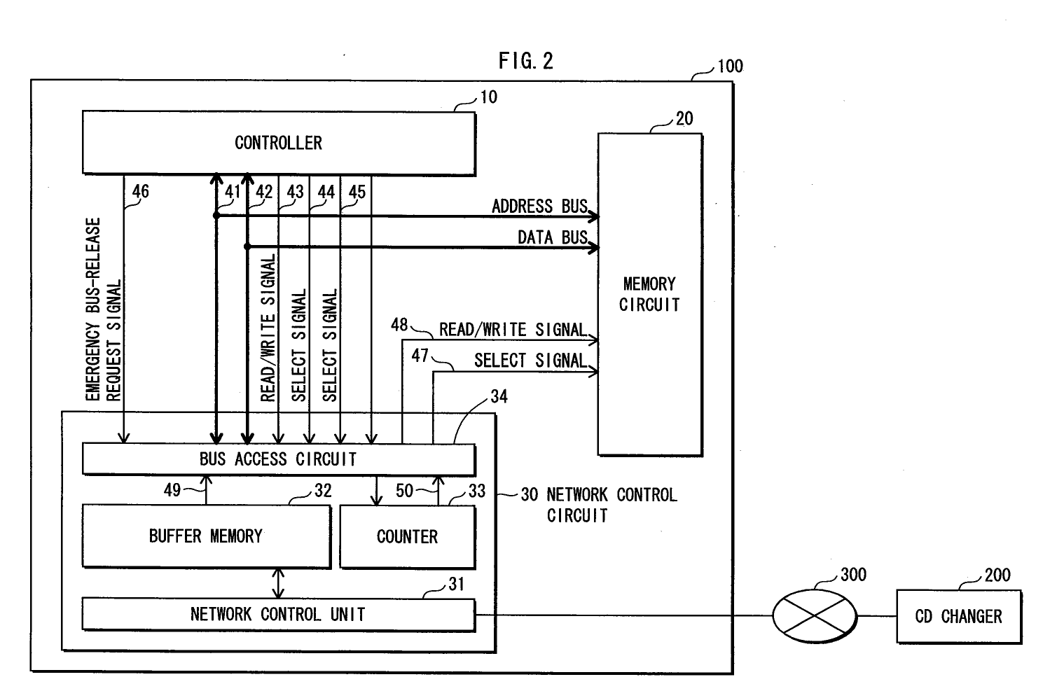

FIG. 2 is structure diagram showing the internal structure of the car navigation system 100. As FIG. 2 shows, the car navigation system 100 includes a controller 10, a memory circuit 20 and a network control circuit 30.

The controller 10, the memory circuit 20, and the network control circuit 30 are interconnected via an address bus 41 and a data bus 42. The controller 10 outputs a read/write signal 43, a select signal 44, and a select signal 45 to the network control circuit 30. The controller 10 asserts the select signal 44 when accessing the network control circuit 30, and asserts the select signal 45 when accessing the memory circuit 20. The network control circuit 30 outputs a select signal 47 and a read/write signal 48 to the memory circuit 20. The network control circuit 30 asserts the select signal 47 when accessing the memory circuit 20.

Note that the address bus 41, the data bus 42 and the read/write signal 48 are collective called as “busses” in the following explanations.

### Read/Write Function of Controller 10

The controller 10 has a function to access the memory circuit 20 and write data in the memory circuit 20 or read data from the memory circuit 20.

### Access-Time Setting Function of Controller 10

The controller 10 has a function to transfer control over the busses to the network control circuit 30 for a prescribed period while not accessing the memory circuit 20, e.g., while performing data communication with a cache. Specifically, the controller 10 transfers control over busses by giving an access permission period to a counter 33 provided in the network control circuit 30. The prescribed period is, for example, a period included in a basic cycle of the network 300. The prescribed period is required for the network control circuit 30 to write certain volumes of data, receivable in the basic cycle of the network 300, into the memory circuit 20. Here, the basic cycle of the network 300 is equivalent to a period required for the network 300 to transfer 1 frame. That is, a period from when a preamble of a frame is detected to when a preamble of the next frame is detected. Regarding the frame, see an explanation in a later section.

Due to the stated function of the controller 10, the network control circuit 30 occupies the busses for the prescribed period within the basic cycle of the network 300, while the controller 10 is not accessing the memory circuit 20. Accordingly, it is possible to avoid increasing the size of the buffer memory 32. Note that the controller 10 may set the access permission period to the counter 33 at any timing in a period while the controller 10 is not accessing the memory circuit 20. For example, within the basic cycle, the controller 10 may set the access permission period to the counter 33 when finishing the first-time access to the memory circuit 20. However, it is required that the controller 10 gives the access permission period at such a timing that the network control circuit 30 can access the memory circuit 20 throughout the given period. Note that the frequency of accesses by the controller 10 to the memory circuit 20 depends on the system.

### Emergency Bus-Release Request Function of the Controller 10

The control unit 10 has a function to output an emergency bus-release request signal 46 to the network control circuit 30 when required to perform emergency processing while the network control circuit 30 is using the busses. The emergency bus-release request signal 46 is used for forcibly suspending the access by the network control circuit 30 to the busses, and transferring the right of access to the controller 10.

Due to the function of making the emergency bus-release request, it is possible to secure the processing environment for the controller 10, even if the network control circuit 30 is using the busses.

### Normal Functions of the Controller 10

The controller 10 performs various controls over the whole car navigation system 100, and various calculations. For example, the controller 10 causes a display apparatus (not illustrated) to display a road map based on road information, and to display a pointer indicating the present position and the traveling direction of the car based on detection by a position detecting apparatus (not illustrated) such as a GPS.

Note that although the controller 10 operates in the same cycle as the basic cycle of the network 300, usually some errors are observed.

The memory circuit 20 is, for example, a flash memory. The controller 10 and the network control circuit 30 writes data into the memory circuit 20.

The network control circuit 30 includes a network control unit 31, a buffer memory 32, a counter 33, and a bus access circuit 34.

The network control unit 31 has a function to receive data from the CD changer 200 connected thereto via the network 300, and store the received data in the buffer memory 32. The network control unit 31 also has a function to transmit data stored in the buffer memory 32 to the CD changer 200. In this regard, the network control unit 31 reads data having a size that is in accordance with the data transfer size, and transmits the data to the CD changer 200.

The buffer memory 32 stores therein data that the network control unit 31 has received from the CD changer 200. Also, the bus access circuit 34 writes data stored in the memory circuit 20 into the buffer memory 32. The buffer memory 32 also outputs an empty signal 49 to the bus access circuit 34. The empty signal 49 is a signal to be asserted when the buffer memory 32 does not store any data therein.

The counter 33 accepts the access permission period pertaining to access from the network control circuit 30 to the busses given by the controller. The counter 33 has a function to automatically decrement the given period after accepting the period. The counter 33 also outputs a counter signal 50 to the bus access circuit 34. The counter signal 50 is a signal to be asserted when the count value indicates the initial value. The initial value is specifically 0.

### Interface Function of the Bus Access Circuit 34

The bus access circuit 34 is an interface to the busses. In other words, the bus access circuit 34 serves as an interface for the controller 10 accessing the internal circuit of the network control circuit 30. The bus access circuit 34 also serves as an interface for the controller 10 accessing the memory circuit 20. In the latter case, the bus access circuit 34 transmits a select signal 47, received from the control unit 10 as the select signal 45, to the memory circuit 20. Also, the bus access circuit 34 transmits a read/write signal 48, received from the control unit 10 as the read/write signal 43, to the memory circuit 20.

Moreover, the bus access circuit 34 has a function to write the data stored in the buffer memory 32 into the memory circuit 20. The bus access circuit 34 also has a function to read the data stored in the memory circuit 20 and writes the read data into the buffer memory 32. To fulfill such functions, the bus access circuit 34 generates the select signal 47 and the read/write signal 48.

As described above, the bus access circuit 34 has a function to generate the select signal 47 and the read-write signal 48 appropriately, in accordance with access from the controller 10 and access from the network control circuit 30.

### Read/Write Function of the Bus Access Circuit 34

In the case where the network control circuit 30 accesses the memory circuit 20, the bus access circuit 34 accesses the memory circuit 20 in accordance with statuses of the empty signal 49 and the counter signal 50. Specifically, in the case of receiving data from the CD changer 200, the bus access circuit 30 read data from the buffer memory 32 and writes the data into the memory circuit 20 when the empty signal 49 and the counter signal 50 are negated. In the case of transmitting data to the CD changer 200, the bus access circuit 30 reads data from the memory circuit 20 and writes the data into the buffer memory 32 when the counter signal 50 is negated.

### <Data>

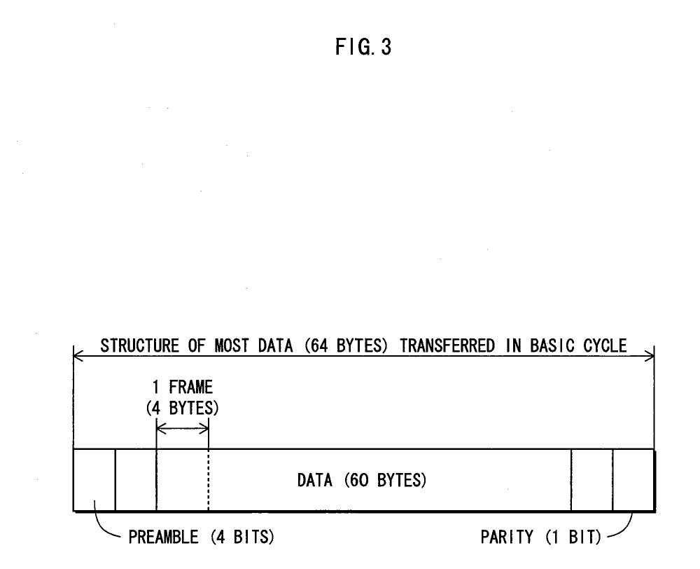

The following describes a data structure pertaining to the present invention. FIG. 3 shows a data structure used in the MOST. In the MOST, data is transferred according to the basic cycle. Such data has a 64-byte structure, and is transmitted at a frame rate of 44.1 kHz for example, which is the CD sampling rate. When the frame rate is 44.1 kHz, the data transfer speed is 22.5 Mbps.

Only a single timing master is included in the network 300. The network control circuit 30 and the CD changer 200 operate in synchronization with a clock source of the timing master. The MOST data is transferred in synchronization with the clock source as well. Fields included in the MOST data transferred in a single basic cycle are defined as FIG. 3 shows. The total length of synchronization data and non-synchronization data is 60 bytes. However, the border therebetween is variable depending on the system. The data area is used by a plurality of devices including the network control circuit 30 by time division. Here, “1 frame” shown in FIG. 3 represents data that the network control circuit 30 can transmit or receive within each basic cycle and that occupies a certain area within the data area of 60 bytes. In the following explanation of a time chart, 1 frame is assumed to have a length of 4 byte. The control channel is 2-byte data, and the preamble, the parity, and the likes have 2-byte length in total. The MOST data transferred in the basic cycle includes a data transfer size. The control channel is used for transferring application massages such as “playback” and “stop” of the CD changer, and control messages used for sending and receiving network management information. The preamble is 4-bit data showing the beginning of the MOST data. The basic cycle of the network begins with the preamble. The parity is 1-bit data used for data error detection. The data transfer size is information showing the size of data to be transferred. In the explanation, 2 bytes are allocated for the control channel included in the MOST data transferred in each basic cycle. However, a control message is actually transferred in units of 32 bytes consisted of data for 16 cycles.

### <Time Chart>

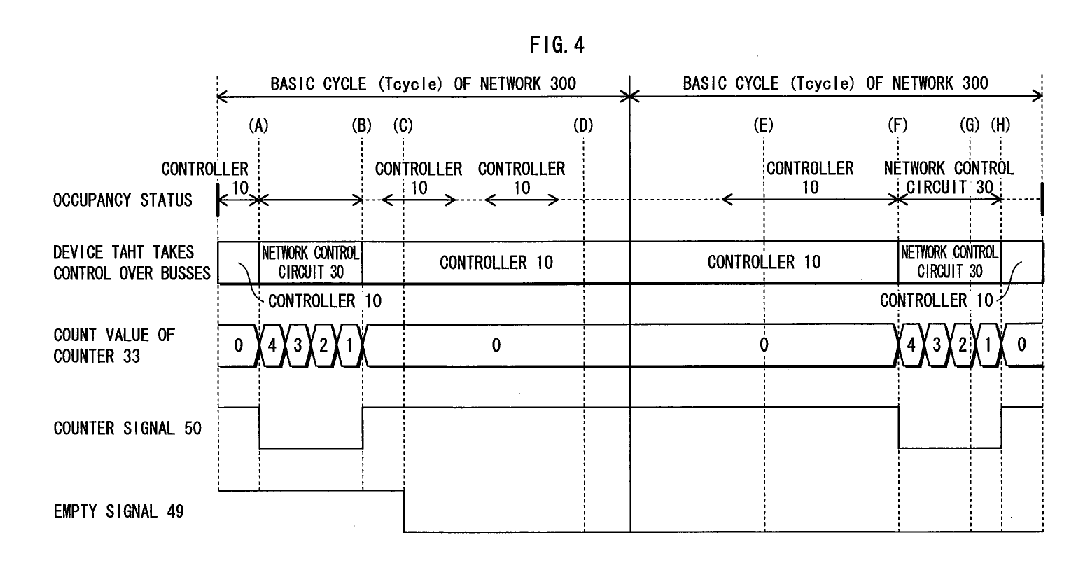

With reference to FIG. 4, the following describes specifications of accesses from the network control circuit 30 to the busses, performed at reception of data from the CD changer 200. In FIG. 4, the basic cycle of the network 300 is assumed as “Tcycle”. FIG. 4 shows accesses from the network control circuit 30 to the busses performed while the network control circuit 30 is receiving 4-byte data from the CD changer 200. Here, as shown in the example above, the access permission period is given at a time within the basic cycle when the first-time access from the controller 10 to the memory circuit 20 finishes.

In FIG. 4, the first level represents an occupancy status of the busses. A period in which access to the busses is performed are represented by an arrow (“←→” shown in the drawing), and the name of a device that performs the access is written above the arrow. The second level shows transition from one device to another that takes control over the busses, and the names of devices that are permitted to access the busses are written here. The third level represents transition of the count value of the counter 33. The fourth level represents the status of the counter signal 50. The fifth level represents the status of the empty signal 49.

As FIG. 4 shows, the controller 10 occupies the busses from the beginning of the basic cycle of the network 300 to the point (A). In this period, the controller 10 accesses the busses, as shown by the occupancy status of the busses. When finishing the access at the point (A), the controller 10 gives an access permission period to the network control circuit 30. In other words, the controller 10 writes “4” into the counter 33. Afterwards, the counter 33 automatically decrements the count value, and the count value returns to the initial value at the point (B). However, in the period from the point (A) to the point (B), the empty signal 49 is kept asserted. This means that the buffer memory 32 has not received data and the network control circuit 30 can not actually access the busses to write the data.

Next, at the point (C), the empty signal 49 is negated because the data received from the CD changer 200 has been stored in the buffer memory 32. At the point (D), all the pieces of data to be received within the basic cycle have been received. Within this basic cycle, the network control circuit 30 has been given an access permission period from the point (A) to the point (B). Accordingly, no more access permission period is to be given to the network control circuit 30. In other words, at the point (B), control over the busses is transferred to the controller 10 again as the occupancy status shows, and the controller 10 accesses the busses afterwards.

Next, the point (E) shows the beginning of data reception in the next basic cycle. The point (G) shows the point when all the pieces of data to be received in this basic cycle have been received. In the period between the points (E) and (G), 4-byte data is newly received.

From the beginning of the new cycle to the point (F), the controller 10 occupies the busses. As the occupancy status shows, the controller 10 accesses the busses in this period only once. At the point (F), when finishing the access to the busses, the controller 10 gives an access permission period to the network control circuit 30. In other words, at the point (F), the controller 10 writes “4” into the counter 33. Afterwards, the counter 33 automatically performs the decrement operation, and the count value returns to the initial value at the point (H). In the period from the point (F) to the point (H), control over the busses is transferred to the network control circuit 30, and the empty signal 49 and the counter signal 50 are negated. Accordingly, the received data is to be written in the memory circuit 20 in this period.

At the point (H), the value of the counter 33 returns to the initial value, and the counter signal 50 is asserted. However, although the 4-byte reception data has been written in the memory circuit 20, new pieces of data is being received in this cycle. Accordingly, the empty signal 49 is not to be asserted. Note that control over the busses is transferred to the controller 10 at the point (H), and the controller 10 accesses the busses afterwards.

The value given to the counter 33 described above is the same as the number of accesses from the network control circuit 30 to the memory circuit 20 performed within the Tcycle. In other words, the data amount (4 bytes) to be received from the CD changer 200 in the Tcycle and the data amount (4 bytes) to be written by the network control circuit 30 into the memory circuit 20 is the same. Accordingly, the buffer memory 32 is required to have a capacity of at least 8 bytes, which is twice the maximum data size to be received from the CD changer 200 in the Tcycle. This means that it is possible to optimize the capacity of the buffer memory 32 according to the system to be structured.

Also, the amount of data to be written into the memory circuit 20 in the access permission period varies depending on the storage status of the buffer memory 32. For example, if the data reception from the network 300 has not been completed, and only 2-byte data is stored in the buffer memory 32, only the 2-byte data is to be written into the memory circuit 20 in this period. However, even in such a case, since an access permission period is to be given to the network control circuit 30 at certain timing in the next basic cycle, the size of data to be stored in the buffer memory 32 does not exceed 8 bytes.

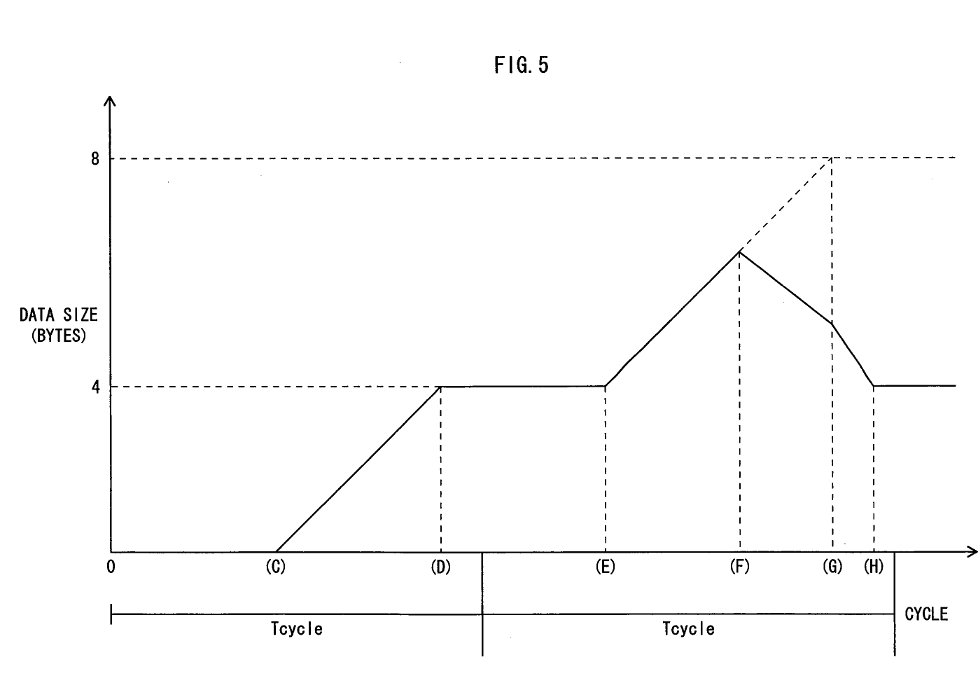

Next, FIG. 5 shows transition of the size of data stored in the buffer memory 32 shown in the time chart of FIG. 4. The vertical axis indicates the size of data stored in the buffer memory 32, and the horizontal axis indicates the cycles. In the period from the point (C) to the point (D) included in the basic cycle, the 4-byte data is being stored in the buffer memory 32. Since the maximum amount of data that can be received in the basic cycle is 4 bytes, no more data will be stored in the buffer memory 32 in this cycle. In the period from the point (E) to (G), another 4-byte data is being stored in the buffer memory 32. Therefore, at the point (G), 8-byte data should be stored in the buffer memory 32. However, at the point (F), an access permission period is set to the counter 33. Accordingly, in the period from the point (F) to the point (H), 4-byte data is being written in the memory circuit 20. In other words, since the 4-byte data stored in the buffer memory 32 in the period from the point (C) to the point (D) is written into the memory circuit 20 in the period from the point (F) to the point (H) on a FIFO basis, the size of the data stored in the buffer memory 32 at the point (H) is 4 bytes, not 8 bytes. Note that from the point (F) to the point (G), the storage of the data into the buffer memory 32 and the writing of the data into the memory circuit 20 are performed simultaneously.

As described above, the buffer memory 32 is required to have a capacity of only 8 bytes, because a period for writing 4-byte data into the memory circuit 20 is given to the network control circuit 30 within the basic cycle. As a result, it is possible to avoid that the size of the buffer memory 32 becomes large.

In the same manner, when transmitting data to the network 300, the network control circuit 30 reads 4-byte data from the memory circuit 20, and transmits the data to the network 300.

### <Time Chart Showing the Case Where an Emergency Bus-Release Request Signal 46 is Output>

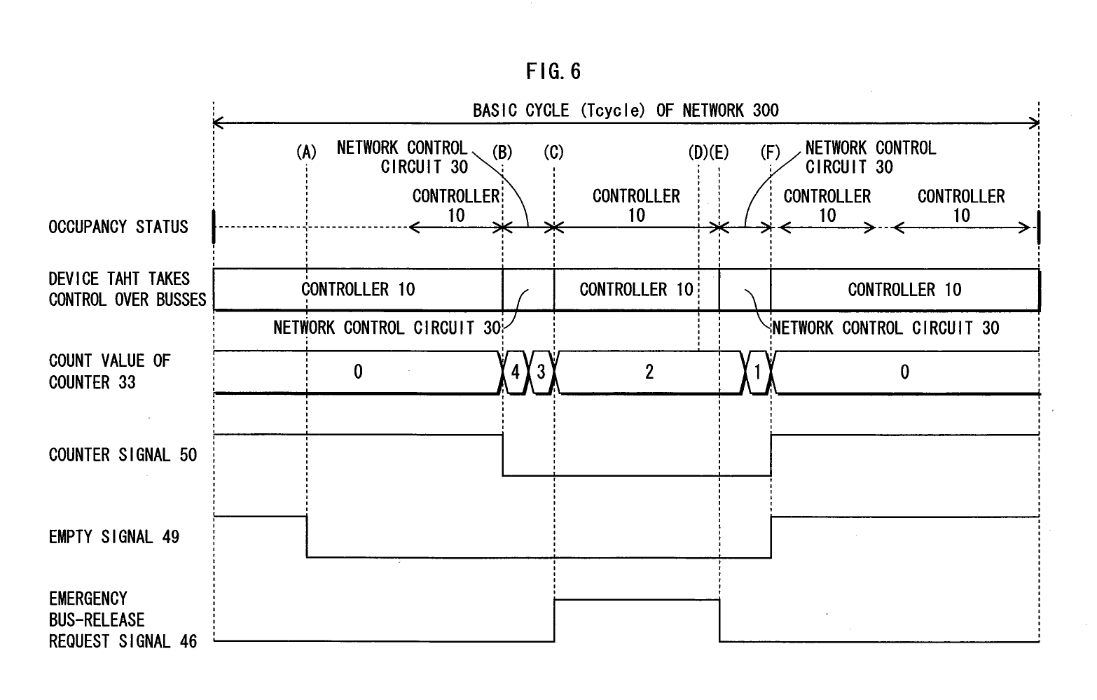

The following describes the case where the controller 10 outputs an emergency bus-release request signal 46 to the network control circuit 30, with reference to FIG. 6. In FIG. 6, the first to the fifth levels are the same as those in FIG. 4. The sixth level shows the status of the emergency bus-release request signal 46.

At the point (A) in FIG. 6, the empty signal 49 is negated because the data received from the CD changer 200 has been stored in the memory 32. From the beginning of the basic cycle of the network 300 to the point (B), the controller 10 occupies the busses. In this period, the controller 10 accesses the busses, as the occupancy status of the busses shows. When finishing the access at the point (B), the controller 10 gives an access permission period to the network control circuit 30. In other words, the controller 10 writes “4” into the counter 33. Afterwards, the counter 33 automatically decrements the count value. However, the emergency bus-release request signal 46 is asserted at the point (C). Accordingly, the network control circuit 30 stops accessing the busses, and transfers control over the busses to the controller 10. Afterwards, the controller 10 occupies the busses, and reads the value of the counter 33 at the point (D), which is immediately before the transfer of control over the busses to the controller 10 is performed, to check the remaining time for the network control circuit 30 to access the busses. After that, the controller 10 negates the emergency bus-release request signal 46 at the point (E) to transfer the control over the busses to the network control circuit 30 so that the network control circuit 30 occupies the busses in the period from the point (E) to the point (F).

As described above, the stated function enables the controller 10 to access the busses in an emergency.

After the emergency bus-release request signal 46 is asserted within a certain basic cycle and the network control circuit 30 stops accessing the busses, the control over the busses is transferred to the controller 10. However, in some cases, the controller 10 occupies the busses for a long time, and it is impossible to give a prescribed period for accessing the memory circuit 20, to the network control circuit 30. In such cases, adjustments may be made in the next cycle. In other words, in a given cycle, a count value “2” may be kept, and the controller 10 may be allowed to access the memory circuit 20 for 6 counts in the next cycle.

Note that it is possible to output a signal indicating that an emergency bus-release request signal has been received or the counter signal 50 to the controller 10.

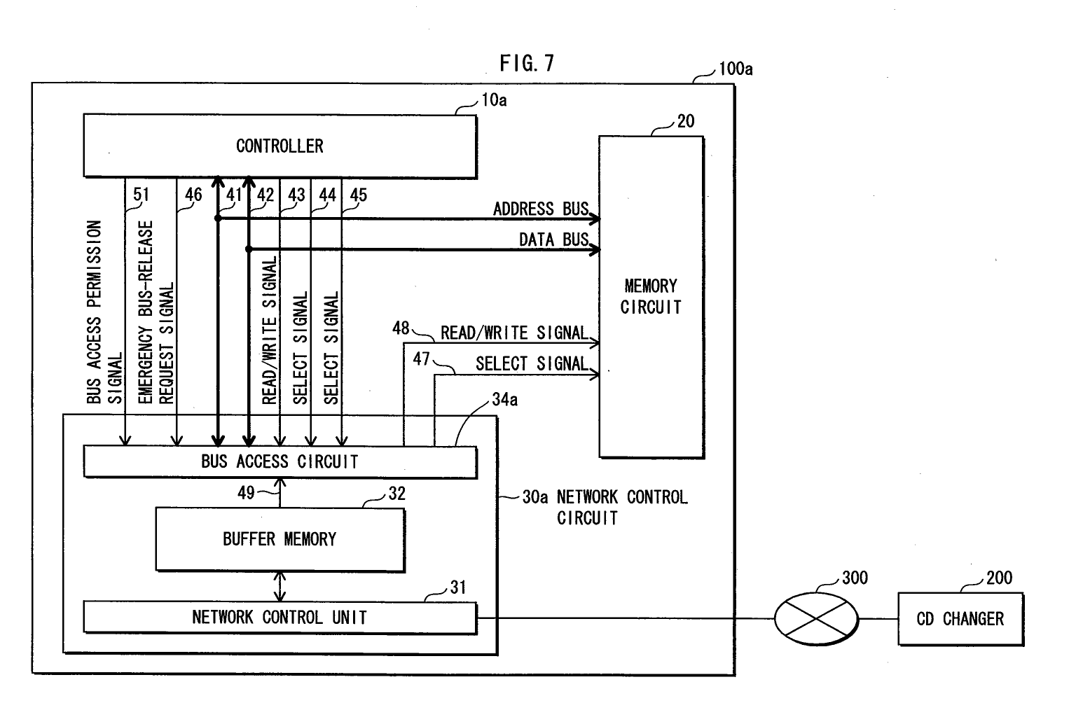

Also, as FIG. 7 shows, a bus access permission signal 51 that is equivalent to the counter signal may be output by a controller 10a to a bus access circuit 34a. The bus access permission signal 51 may be output with use of a general purpose port of the controller 10a. If this is the case, a value “1” may be set to the output port when access to the busses is performed, and a value “0” may be set to the output port when the access finishes. Since the general purpose port is an internal resource of the controller 10a, the access is easier and the access speed is faster compared to the write access to the counter, which is an external resource of the controller 10a.

According to the first embodiment described above, a prescribed period included within the basic cycle (Tcycle) of the network is secured as an access period for the network control circuit 30. A certain volumes of data that can be received or transmitted within the basic cycle is written into the memory circuit 20 or read from the memory circuit 20 in the prescribed period. Accordingly, the required capacity of the buffer memory 32 incorporated in the network control circuit 30 is only twice as the maximum size of data that can be received or transmitted within the basic cycle of the network 300, and it is unnecessary for the buffer memory 32, which is to be incorporated into the network control circuit 30, to have a large capacity. Also, it is possible to improve the processing efficiency of the whole system by eliminating the bus-release processing of the controller 10.

### The Second Embodiment

The following describes the second embodiment of the present invention. In the second embodiment, a network control circuit 30b performs access control by transmitting a wait signal 70 to a controller 10b.

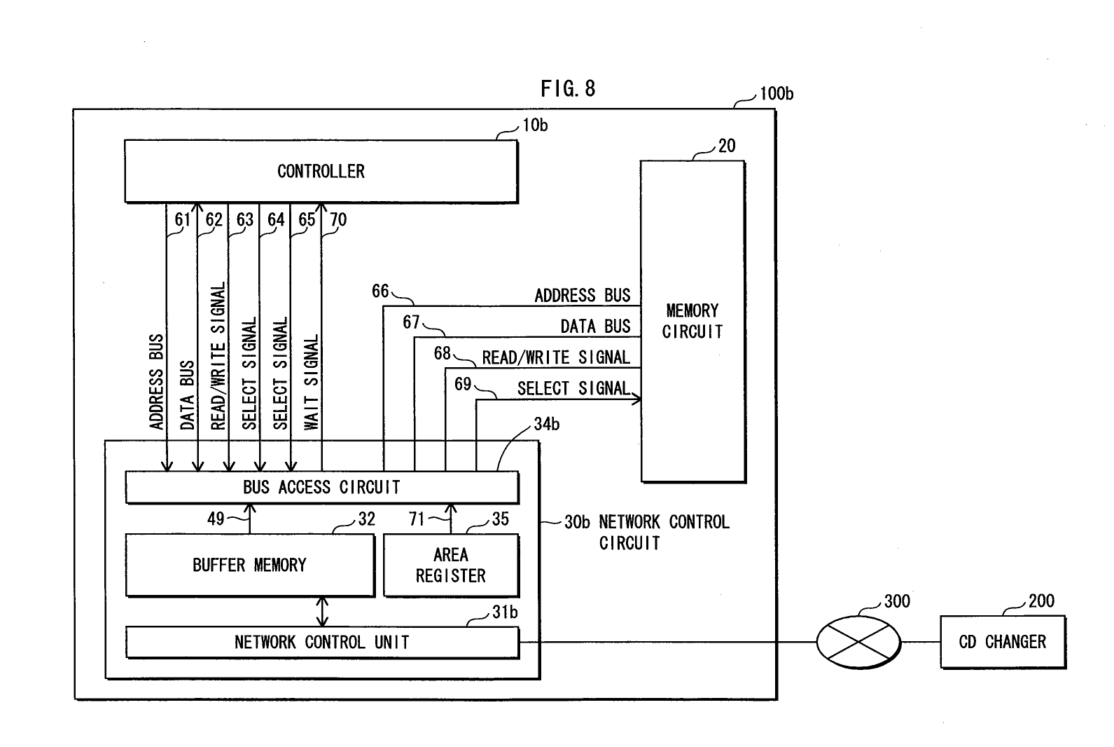

FIG. 8 shows the internal structure of a car navigation apparatus 100b pertaining to the second embodiment. As FIG. 8 shows, the car navigation apparatus 100b includes a controller 10b, a memory circuit 20, and a network control circuit 30b. The controller 10b and the network control circuit 30b are connected to each other via an address bus 61, a data bus 62, a signal line for a read/right signal 63, a signal line for a select signal 64 that is to be asserted when the controller 10b accesses the network control circuit 30b, a signal line for a select signal 65 that is to be asserted when the controller 10b accesses the memory circuit 20, and a signal line for a wait signal 70 that is to be used when the network control circuit 30b controls accesses performed by the controller 10b. The network control circuit 30b and the memory circuit 20 are connected to each other via an address bus 66, a data bus 67, a signal line for a read/write signal 68, and a signal line for a select signal 69.

The controller 10b has a function to access the memory circuit 20 and write or read data. Also, the controller 10b receives the wait signal 70 from the network control circuit 30b. The wait signal 70 changes to “0” when the access to the memory circuit 20 begins, and changes to “1” when the access to the memory circuit 20 finishes.

The memory circuit 20 is the same as that of the first embodiment.

The network control circuit 30b includes a network control unit 31b, a buffer memory 32, a bus access circuit 34b, and an area register 35.

The network control unit 31b has a function to receive data from a CD changer 200 connected thereto via a network 300, and store the received data in the buffer memory 32. The network control unit 31b also has a function to take out data, having a size that is in accordance with the data transfer size, from the shared memory, and transmit the data to the CD changer 200.

The buffer memory 32 is the same as that of the first embodiment.

The bus access circuit 34b is connected to the controller 10b and the memory circuit 20 via different busses. The bus access circuit 34b outputs the wait signal 70 to the controller 10b, to control accesses performed by the controller 10b.

The select signal 69 is generated by superimposing the select signal 65 on a select signal that is generated when the network control circuit 30b accesses the memory circuit 20. The read/write signal 68 is generated by superimposing the read/write signal 63 on a read/write signal that is generated when the network control circuit 30b accesses the memory circuit 20. Each of the signals is used by the bus access circuit 34b to control accesses to the memory circuit 20, based on whether the controller 10b is accessing the memory circuit 20, the status of an area matching signal 71 (described later), and the status of the empty signal 49.

Specifically, if the controller 10b is accessing the memory circuit 20, the bus access circuit 34b restricts access by the network control circuit 30b to the memory circuit 20, depending on the status of the area matching signal 71. In other words, if the area matching signal 49 is asserted, only the controller 10b accesses the memory circuit 20.

If the controller 10b is not accessing the memory circuit 20, the network control circuit 30b accesses the memory circuit 20 to read or write data having a size that can be transferred within the basic cycle of the network 300 from or to the memory circuit 20. More specifically, the network control circuit 30b accesses the memory circuit 20 depending on the status of the empty signal 49. In the case of receiving data from the CD changer 200, the network control circuit 30b reads data from the buffer memory 32 while the empty signal 49 is negated, and writes the data into the memory circuit 20. However, in the case of transmitting data to the CD changer 200, the network control unit 31b reads data having a size indicated by the data transfer size from the memory circuit 20 within the basic cycle, and transmits the data to the CD changer 200.

The area register 35 holds a prescribed address range of memory areas included in the memory circuit 20. The prescribed address range defines an address range where speed of access from the controller 10b to the memory circuit 20 is not allowed to decrease. Also, the area register 35 outputs the area matching signal 71 to the bus access circuit 34b. The area matching signal 71 is asserted when the value of the address bus is included within the range held by the area register 35.

### <Time Chart Showing Data Reception>

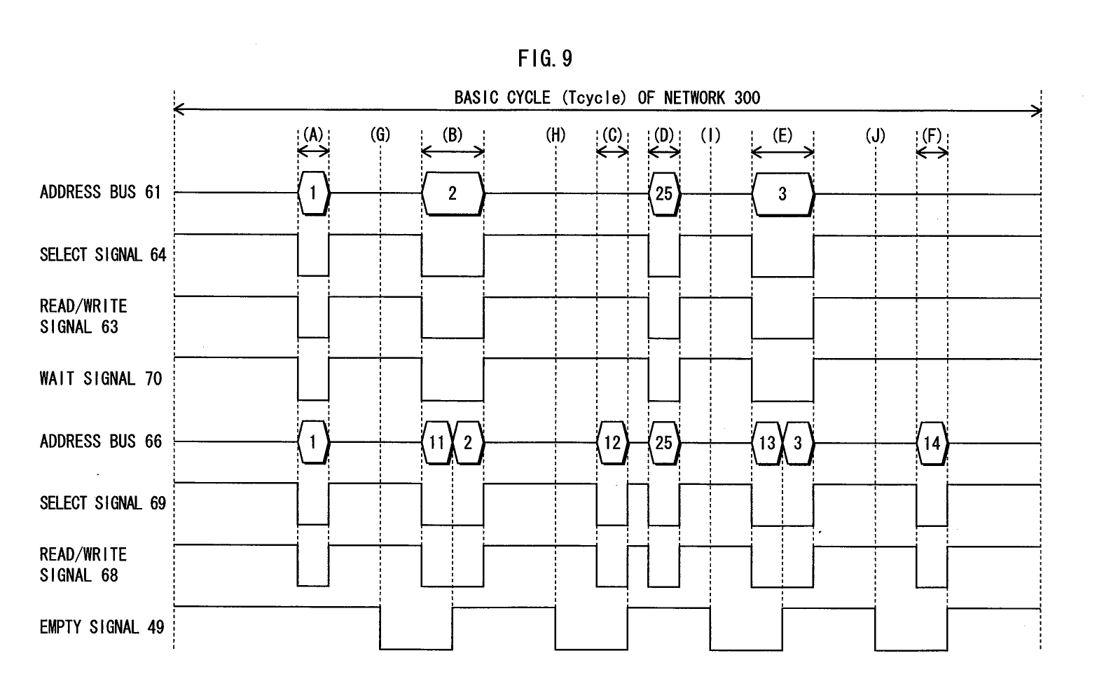

With reference to FIG. 9, the following describes specifications of accesses performed at reception of data from the network 300. Note that in FIG. 9, the network control circuit 30b sequentially stores pieces of data received from the network 300 into areas included in the memory circuit 20 having addresses 11-14. Also note that the area register 35 holds an address range from an address 20 to an address 50.

In FIG. 9, the first level represents the address bus 61. The second level represents the select signal 64. The third level represents the read/write signal 63. The fourth level represents the wait signal 70. The fifth level represents the address bus 66. The sixth level represents the select signal 69. The seventh level represents the read/write signal 68. The eighth level represents the empty signal 49. The numbers shown at the first level and the fifth level are the addresses of memory areas included in the memory circuit 20.

In the period (A), the controller 10b accesses the address 1 in the memory circuit 20. However, since the buffer memory 32 does not store any data therein, the empty signal 49 is being asserted at this moment. A signal of the address bus 61, the select signal 64 and the read/write signal 63 are output, to the memory circuit 20, as a signal of the address bus 66, the select signal 69 and the read/write signal 68 respectively. Here, the controller 10b is required to sustain the signal of the address bus 61, the select signal 64 and the read/write signal 63 until the wait signal 70 changes from “0” to “1”.

At the point (G), since the data received from the network 300 is stored in the buffer memory 32, the empty signal 49 is being negated. Accordingly, the bus access circuit 34b attempts to perform write access to the memory circuit 20 at the beginning of the period (B). However, since the controller 10b accesses the address 2 in the memory circuit 20 at the same time, the bus access circuit 34b firstly writes the data from the buffer memory 32 in the memory circuit 20 at the address 11, and then controls the controller 10b to access the address 2 in the memory circuit 20. In the period (B), the wait signal 70 is applied to the controller 10b for a longer time than in the period (A). Accordingly, the controller 10b can complete the access regardless of the access by the network control circuit 30b to the memory circuit 20. The empty signal 49 is asserted after the data from the buffer memory 32 is written in the memory circuit 20 at the address 11.

As described above, it is unnecessary for the controller 10b to control access to the busses performed by the network control circuit 30b.

Next, at the point (H), since the data received from the network 300 is stored in the buffer memory 32 again, the empty signal 49 is negated. Accordingly, the bus access circuit 34b attempts to perform write access to the memory circuit 20 at the beginning of the period (C). In the period (C), since the controller 10b does not access the memory circuit 20, the bus access circuit 34b stores the received data in the memory circuit 20 at the address 12. The empty signal 49 is asserted after the data from the buffer memory 32 is written in the memory circuit 20 at the address 12.

Next, in the period (D), the controller 10b attempts to access at the address 25. However, since the address 25 is included in the address range (addresses 20-50) held by the area register 35, only the controller 10b accesses the memory circuit 20 in this period. As a result, the controller 10b can complete the access to the memory circuit 20 in the shortest time, without extending the period during which the wait signal is being applied in the same manner as in the period (B). This is particularly effective if it is necessary to avoid extension of the access time, which is, for example, in the case where the tasks to be performed by the controller 10b include calculations that should be performed within a prescribed period with use of the data stored in the memory circuit 20.

Next, at the point (I), since the data received from the network 300 is stored in the buffer memory 32 again, the empty signal 49 is negated. In the period (E), the controller 10b accesses the address 3 in the memory circuit 20. This address is out of the address range held by the area register 35. Accordingly, the controller 10b accesses the memory circuit 20 in the same manner as in the period (B). The empty signal 49 is asserted after the data from the buffer memory 32 is written in the memory circuit 20 at the address 13. At the point (J), since the data received from the network 300 is stored in the buffer memory 32, the empty signal 49 is negated. In the period (F), since the controller 10b does not access the memory circuit 20, the bus access circuit 34b accesses the memory circuit 20 in the same manner as in the period (C). Note that the writing of the received 4-byte data into the memory circuit 20 is completed and the empty signal 49 is asserted at the end of the period (F).

### <Time Chart Showing Data Transmission>

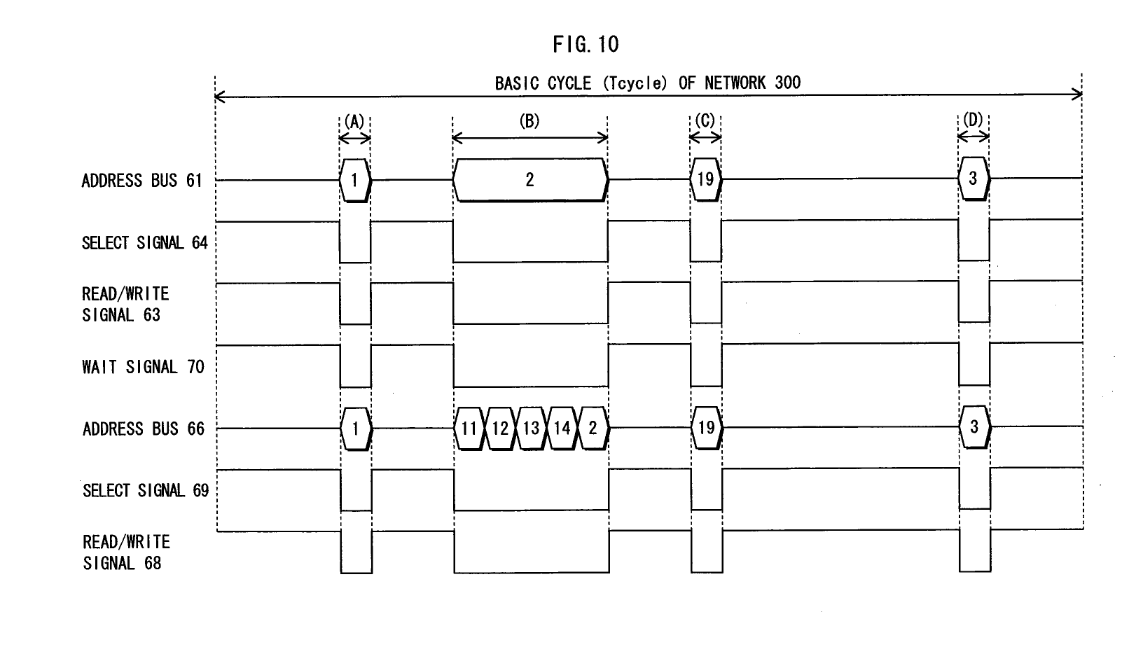

With reference to FIG. 10, the following describes specifications of accesses at transmission of data to the network 300. Note that in FIG. 10, the network control circuit 30b sequentially accesses the addresses 11-14 in the memory circuit 20, reads data, and transmits the data to the network control unit 31b without storing the data in the buffer memory 32. Also note that the area register 35 holds an address range from an address 20 to an address 50.

In FIG. 10, the first level represents the address bus 61. The second level represents the select signal 64. The third level represents the read/write signal 63. The fourth level represents the wait signal 70. The fifth level represents the address bus 66. The sixth level represents the select signal 69. The seventh level represents the read/write signal 68. The numbers shown at the first level and the fifth level are the addresses of memory areas included in the memory circuit 20.

In the period (A), the controller 10b accesses the address 1 in the memory circuit 20. A signal of the address bus 61, the select signal 64 and the read/write signal 63 are output, to the memory circuit 20, as a signal of the address bus 66, the select signal 69 and the read/write signal 68 respectively. Here, the controller 10b is required to sustain the signal of the address bus 61, the select signal 64 and the read/write signal 63 until the wait signal 70 changes from “0” to “1”.

At the beginning of the period (B), the bus access circuit 34b attempts to perform read access to the memory circuit 20. However, since the controller 10b accesses the address 2 in the memory circuit 20 at the same time, the bus access circuit 34b reads data having a size indicated by the data transfer size, and transmits the data to the network control unit 31b. In other words, the bus access circuit 34b reads data from the addresses 11 to 14 in the memory circuit 20, transmits the data to the network control unit 31b. After that, the bus access circuit 34b controls the controller 10b to access the address 2 in the memory circuit 20. In the period (B), the wait signal 70 is applied to the controller 10b for a longer time than in the period (A). Accordingly, the controller 10b can complete the access regardless of the access by the network control circuit 30b to the memory circuit 20.

In the period (C), the controller 10b accesses the address 19 in the memory circuit 20. In the period (D), the controller 10b accesses the address 3 in the memory circuit 20.

### Supplementary Explanations

The network control apparatus pertaining to the present invention is described above based on the embodiments. However, the present invention is not limited to the embodiments.

The above embodiments are based on the assumption that there is difference between the basic cycle of the network and the cycle of the controller 10. However, if it is assured that the basic cycle of the network and the cycle of the controller 10 is the same, it is possible to further reduce the size of the buffer memory. This is because the data received within the basic cycle can be written in the memory circuit 20 or read from the memory circuit 20 within the same basic cycle. In other words, in the example of the first embodiment, by equating the amount of data (4 bytes) to be received from the CD changer 200 within the Tcycle and the amount of data (4 bytes) that the network control circuit 30 writes in the memory circuit 20 within the Tcycle, the capacity of the buffer memory 32 can be as small as 4 bytes, which is the maximum amount of the data received from the CD changer 200 within the Tcycle.

In the second embodiment, two select signals, namely the select signal 64 and the select signal 65, are output from the controller to the network control circuit, as FIG. 8 shows. However, it is possible to perform access between the controller 10b and the network control circuit 30c without using the select signal 65. Accordingly, it is also possible to structure a system at low cost with a controller 10c that uses only one select signal.

In the embodiments above, the in-vehicle network is the MOST network. However, the present invention is not limited to this. The network may be the CAN (Controller Area Network) or the IDB-1394.

In the embodiments above, the network control apparatus is used in a car navigation apparatus. However, the present invention is not limited to this. The network control apparatus may be used in an apparatus connected to an in-vehicle network of a plane, a train, a ship and so on.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A network control circuit that is connected to a controller and a shared memory via busses and to an external apparatus via a network, and stands between the controller and the external apparatus, the network control circuit comprising:
a transmission/reception unit operable to transmit/receive data having a prescribed size to/from the external apparatus in each of transmission cycles of the network;
a buffer memory operable to store the data; and
a read/write unit operable to read data having a size not greater than the prescribed size from the buffer memory/the shared memory, and write the read data into the shared memory/the buffer memory within a prescribed period included in each of the transmission cycles in which the controller does not use the busses, the size of the data to read depending on a storage status of the buffer memory.

2. The network control circuit of claim 1, further comprising
a count unit operable to decrement a count value that has been set by the controller,
wherein the prescribed period is a period between when the count value is set and when the count value reaches a prescribed value.

3. The network control circuit of claim 1,
wherein the read/write unit includes
a reception subunit operable to receive, from the controller, a bus access permission signal indicating a permission for access to the busses, and
the prescribed period is a period during which the reception subunit is receiving the bus access permission signal.

4. The network control circuit of claim 1,
wherein the read/write unit includes
a reception subunit operable to receive, from the controller, an emergency bus-release request signal that requests to release the busses, and
a control subunit operable to forcibly suspend processing performed by the read/write unit for a period during which the emergency bus-release request is being asserted, and cause the read/write unit to resume the processing when the emergency bus-release request is negated.

5. The network control circuit of claim 1,
wherein the data having the prescribed size is music data, and the transmission/reception unit transmits/receives the data in each of the transmission cycles whose rate is the same as a sampling rate used for encoding the music data.

6. The network control circuit of claim 1,
wherein a capacity of the buffer memory is based on a maximum data size receivable from the external apparatus within each of the transmission cycles.

7. A network control circuit that is connected to a controller via a first bus, to a shared memory via a second bus, and to an external apparatus via a network, and stands between the controller and the external apparatus, the network control circuit comprising:
a transmission/reception unit operable to transmit/receive data having a prescribed size to/from the external apparatus in each of transmission cycles of the network;
a buffer memory operable to store the data;
a detection unit operable to detect an access from the controller to the shared memory;
a first read/write unit operable to write the data having the prescribed size into the shared memory, or read the data having the prescribed size from the shared memory;
a second read/write unit operable to access the shared memory to read or write data when the detection unit detects the access from the controller to the shared memory; and
a transmission unit operable to transmit a wait signal to the controller when the detection unit detects the access from the controller to the shared memory, in order to restrict a further access from the controller to the shared memory during a period from when the detection unit detects the access to when the second read/write unit finishes accessing the shared memory.

8. The network control circuit of claim 7, further comprising:
a storage unit that stores address information showing a prescribed range of addresses of memory areas included in the shared memory; and
a control unit operable to permit only access from the controller when the controller accesses an address included within the prescribed range.
